(19) United States
(12) Patent Application Publication
(10) Pub. No.: US 2013/0149477 A1
(43) Pub. Date: Jun. 13, 2013

(54) HIGH PERFORMANCE INSULATED PANEL

(71) Applicant: Fred L. MINELLI, Carrollton, TX (US)

(72) Inventor: Fred L. MINELLI, Carrollton, TX (US)

(73) Assignee: KYSOR PANEL SYSTEMS DIVISION OF WELBILT WALK-INS, LP, Fort Worth, TX (US)

(21) Appl. No.: 13/712,158

(22) Filed: Dec. 12, 2012

Related U.S. Application Data
(60) Provisional application No. 61/569,745, filed on Dec. 12, 2011.

(51) Int. Cl. B32B 1/02

(52) U.S. Cl. CPC B32B 1/02
USPC 428/34.2; 428/34.1; 428/34.7; 428/36.5; 428/36.1

(57) ABSTRACT

The structural panels of the present disclosure have vacuum-sealed panels within an interior volume. The interior volume also comprises cured foam. The vacuum-sealed panels have filler material and empty space therein, which makes the structural panel lighter than other panels that are filled completely with foam. The air within the vacuum-sealed panels also provides insulation against heat loss.

### CROSS-REFERENCE TO RELATED APPLICATIONS

The present application claims priority to U.S. Provisional Patent Application No. 61/569,745, filed on Dec. 12, 2011, which is herein incorporated by reference.

### BACKGROUND OF THE DISCLOSURE

1. Field of the Disclosure

The present disclosure relates to structural panels used in food storage applications, such as walk-in refrigerators or freezers. More particularly, the present disclosure relates to structural panels that have vacuum panels inside, which provide increased insulation.

2. Description of the Related Art

Many walk-in cold storage facilities use insulated structural panels to line the walls, ceiling, and/or floor of the cold-storage unit to maintain a cold temperature as efficiently as possible. There is a continuing need to improve the efficiency of these panels while still maintaining ease of use and low cost.

### SUMMARY OF THE DISCLOSURE

The present disclosure provides a structural panel comprising interior and exterior panel skins that define an interior space, insulating foam that is poured into the interior space and allowed to set, and at least one vacuum panel within the interior space. The vacuum panel is sealed, with a metal foil exterior, and is filled partially with material such as shredded plastic, fabric, paper, glass, or other suitable materials. The vacuum panel thus provides an extra level of insulation, as the air and materials inside the vacuum panel help to prevent the transfer of heat energy across the structural panel.

Thus, in one embodiment, the present disclosure provides a structural panel. The panel comprises a first wall member and a second wall member in spaced parallel relation and defining an interior space between them, a polymer foam layer in the interior space, and a vacuum-sealed panel in the interior space. The vacuum-sealed panel is partially filled with a filler material.

### BRIEF DESCRIPTION OF THE DRAWINGS

FIG. 1 shows a first embodiment of the structural panel of the present disclosure;

FIG. 2 shows a second embodiment of the structural panel of FIG. 1; and

FIG. 3 shows a third embodiment of the structural panel of FIG. 1.

### DETAILED DESCRIPTION OF THE DISCLOSURE

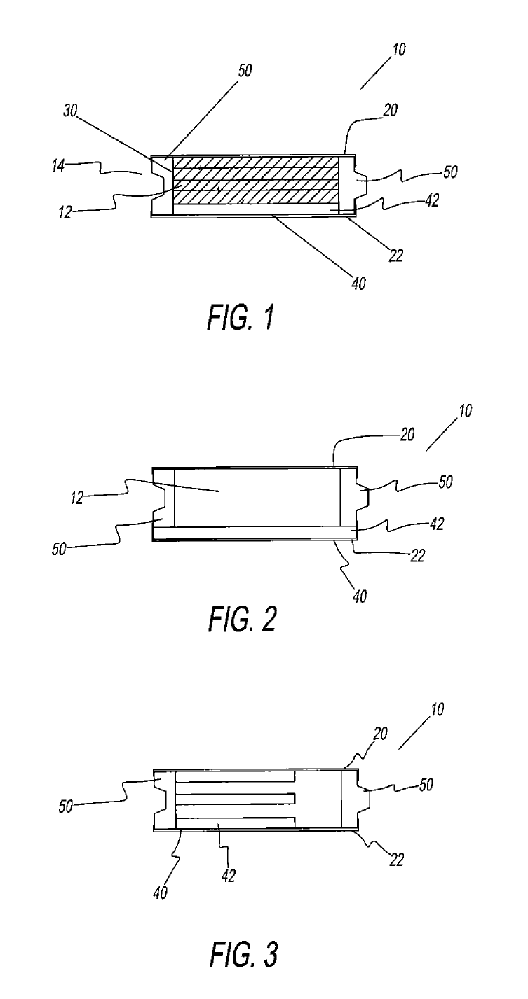

Referring to FIGS. 1-3, structural panel 10 is shown. Panel 10 comprises interior skin 20, exterior skin 22, foam layer 30, at least one vacuum panel 40, and optional framing members 50. Panel 10 is assembled by forming the desired shape in the manner discussed below, with interior skin 20, exterior skin 22, and optionally, two framing members 50 at opposite ends. Interior space 12 is filled with poured foam, which sets and forms foam layer 30. At least one vacuum panel is also placed within interior space 12, and aligned generally parallel to interior skin 20 and exterior skin 22.

Vacuum panel 40 is a flexible structure with an interior volume 42. The exterior surface 44 can be made of metal foil, which is vacuum-sealed. The interior volume 42 is partially filled with a material such as shredded plastic, fabric, paper, glass, other suitable materials, or a combination thereof, so that the remaining space within interior volume 42 not taken up by the filler material is air. The material within interior volume 42 may have a cell structure that traps air, to improve the insulation ability of vacuum panel 40, and thus structural panel 10. The thickness of vacuum panel 40 can be from ¼″ (one-quarter inch) to 3″ (three inches).

Vacuum panel 40 provides an extra level of insulation not available in current panels, as the air within vacuum panel 40 adds to the insulation provided by foam layer 30. Panel 10 thus is simple and inexpensive to manufacture, yet provides for enhanced insulation over currently available panels. Panel 10 also allows users to meet with increasingly stringent requirements from governmental agencies such as the Environmental Protection Agency and the Department of Energy regarding thermal efficiency and restrictions on the types of permissible blowing agents used with the foam in layer 30. Panel 10 may also be thinner than currently available panels with similar efficiency and insulation characteristics, due to the use of vacuum panel 40. Thus, while panel 10 may be more expensive or more difficult to manufacture due to the use of vacuum panel 40, the advantages are significant.

In FIG. 1, vacuum panel 40 is parallel to interior skin 20 and exterior skin 22, and extends between framing members 50 (when present). Panel 40 can be located at several places within interior space 12, indicated by the dotted lines in FIGS. 1 and 3. It can be adjacent to or touching either or both of interior skin 20 and exterior skin 22, or away from them. Referring to FIGS. 2 and 3, alternate placements of vacuum panel 40 are shown. In FIG. 2, vacuum panel 40 extends the entire length of each of interior skin 20 and exterior skin 22, so that the ends of framing members 50 touch vacuum panel 40. In FIG. 3, vacuum panel 40 does not extend along the entire length of interior space 12. The embodiment of FIG. 3 is advantageous in that it allows for the user to place mounting fasteners in or through one side of interior skin 20 and/or exterior skin 22 without puncturing the seal on vacuum panel 40. Again, as discussed above, there can be one or more vacuum panels 40 within interior space 12.

To form structural panel 10, interior skin 20, exterior skin 22, vacuum panel 40, and framing members 50, if present, are placed in a mold that holds them in the desired shape. Foam is then injected into the mold, and fills interior space 12 wherever vacuum panel 40 is not, and the foam is then cured. Pourable foams such as urethane are preferred, but the present disclosure also contemplates the use of expanded or extruded foams such as polystyrene. When framing members 50 are not used, a portion of the cured foam will be exposed along a side 14 of panel 10 where interior skin 20 and exterior skin 22 do not meet. Framing members 50 allow for the connection of adjacent panels 10 in a tongue-and-groove manner when installed. When vacuum panel 40 is not adjacent to or touching either of interior skin 20 or exterior skin 22 when forming panel 10, one or more spacers (not shown) can be used to ensure that vacuum panel 40 is held at the desired height or location during formation of panel 10.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A structural panel, comprising:
a first wall member and a second wall member in spaced parallel relation and defining an interior space between them;
a polymer foam layer in said interior space; and
a vacuum-sealed panel in said interior space, wherein said vacuum-sealed panel is partially filled with a filler material.

2. The structural panel of claim 1, wherein said vacuum-sealed panel contacts one of said first wall member and said second wall member, so that said vacuum-sealed panel is between said polymer foam layer and said one of said first wall member and said second wall member.

3. The structural panel of claim 1, wherein said vacuum-sealed panel is spaced apart from said first wall member and said second wall member so that said foam layer surrounds said vacuum-sealed panel.

4. The structural panel of claim 1, wherein said vacuum-sealed panel is a plurality of vacuum-sealed panels within said interior space.

5. The structural panel of claim 1, wherein said first wall member, said second wail member, and said vacuum-sealed panel have equal lengths.

6. The structural panel of claim 1, wherein said first wall member and said second wall member each have a first length, and said vacuum-sealed panel has a second length that is shorter than said first length.

7. The structural panel of claim 1, wherein said filler material comprises a material selected from the group consisting of plastic, paper, fabric, glass, or any combinations thereof.

8. The structural panel of claim 1, further comprising a pair of framing members, wherein each of said framing members are connected to opposite ends of said first wall member and said second wall member.

9. The structural panel of claim 1, wherein said vacuum-sealed panel extends from one of said pair of framing members to the other of said pair of framing members.
